(19) United States
(12) Patent Application Publication
(10) Pub. No.: US 2024/0318484 A1
(43) Pub. Date: Sep. 26, 2024

(54) FITTING FOR MOVABLY MOUNTING A PIVOTING ELEMENT

(71) Applicant: Julius Blum GmbH, Hoechst (AT)

(72) Inventors: Thomas SCHULER, Hard (AT); Heike SELTMANN, Dornbirn (AT); Andreas HOLZAPFEL, Bregenz (AT)

(21) Appl. No.: 18/732,026

(22) Filed: Jun. 3, 2024

Related U.S. Application Data
(63) Continuation of application No. PCT/EP2022/082783, filed on Nov. 22, 2022.

(30) Foreign Application Priority Data
Dec. 14, 2021 (EP) 21214292.1

(51) Int. Cl. E05F 3/20; A47B 96/00

(52) U.S. Cl. CPC E05F 3/20; A47B 96/00; A47B 2220/0072; E05Y 2201/212; E05Y 2201/266; E05Y 2201/41; E05Y 2201/422; E05Y 2900/132; E05Y 2900/148; E05Y 2900/20

(57) ABSTRACT

A fitting such as a hinge can movably support a pivoting element relative to a stationary carrier. The fitting includes a first fitting portion to be fixed to a carrier, a second fitting portion configured to be fixed to the pivoting element, and a hinge lever pivotally supported about a hinge axis. The hinge lever hingedly connects the first fitting portion and the second fitting portion to each other. A spring device can move the first and second fitting portions into a closed position and/or into an open position relative to each other. A portion, preferably an end portion, of the spring device is supported on a support element, and the support element supporting the spring device is rotationally mounted, preferably on the hinge lever.

The present application is a continuation of International Application PCT/EP2022/082783 filed on Nov. 22, 2022. Thus, all of the subject matter of International Application PCT/EP2022/082783 is incorporated herein by reference.

### BACKGROUND OF THE INVENTION

The present invention relates to a fitting, in particular a hinge, for movably supporting a pivoting element, in particular for movably supporting a furniture part, a window or a door, relative to a stationary carrier. The fitting includes:
a first fitting portion to be fixed to the stationary carrier,
a second fitting portion to be fixed to the pivoting element,
at least one hinge lever pivotally supported about at least one hinge axis, the at least one hinge lever hingedly connecting the first fitting portion and the second fitting portion to each other,
at least one spring device for moving the two fitting portions into a, preferably fully, closed position and/or into a, preferably fully, open position relative to each other, and
at least one support element on which a portion, preferably an end portion, of the spring device is supported.

Moreover, the invention relates to an item of furniture comprising a stationary carrier, in particular a furniture carcass, a pivoting element, in particular a movable furniture part, movable relative to the stationary carrier, and at least one fitting of the type to be described.

DE 79 14 231 U1 discloses a furniture hinge, in which a hinge arm to be fixed to the furniture carcass and a hinge cup to be fixed to the movable furniture part are pivotally connected to each other via two hinge levers. The furniture hinge is held in the closed end position by a spring device in the form of a coiled leg spring. The leg spring is formed of a spring wire having a rectangular cross-section. In this way, a larger spring force can be stored in the leg spring, in a direct comparison with a spring wire having a round cross-section and an identical spring length. The leg spring is supported on one of the two hinge levers on the one hand, and is supported on an underside of the hinge arm on the other hand. Due to the rectangular cross-section of the spring wire, a line contact is present between the ends of the spring, the hinge arm and the hinge lever. As a result, a favorable load distribution can be achieved in comparison with a leg spring made of a round spring wire. However, the frictional resistance between the leg spring and the hinge arm on the one hand, and between the leg spring and the hinge lever on the other hand is increased. As a result, the wear of the hinge and the required forces for moving the hinge are also increased.

### SUMMARY OF THE INVENTION

It is an object of the present invention to propose a fitting as mentioned in the introductory part, thereby avoiding the drawbacks as discussed above. In particular, the frictional conditions of the fitting shall be improved.

According to the invention, the at least one support element for supporting the spring device is rotationally mounted, preferably on the at least one hinge lever.

In other words, at least one rotationally mounted support element for supporting a leg of the spring device is provided, so that a rolling friction is present between the mutually bearing surfaces of the spring device and of the bearing element. A force of a rolling friction, with an identical pressing force, is usually less than a force of a gliding friction. In this way, the wear of the fitting and the forces required for moving the fitting can be reduced, and the lifespan of the fitting can be increased.

Basically, it is possible that the at least one support element is rotationally arranged on the first fitting portion, on the second fitting portion and/or on the at least one hinge lever of the fitting.

According to a preferred embodiment, the fitting includes an inner hinge lever and an outer hinge lever, and the at least one support element is rotationally arranged on the inner hinge lever.

The item of furniture according to the invention includes a stationary carrier, in particular a furniture carcass, a pivoting element, in particular a movable furniture part, movable relative to the stationary carrier, and at least one fitting of the type in question. The first fitting portion of the fitting is fixed to the stationary carrier, and the second fitting portion of the fitting is fixed to the pivoting element.

### BRIEF DESCRIPTION OF THE DRAWINGS

Further details and advantages of the present invention result from the following description of figures, in which:

FIG. 1 is a perspective view of an item of furniture comprising a pivoting element and fittings for movably supporting the pivoting element,

FIG. 2a, 2b are perspective views of a fitting with a damper in a separated condition and in a connected condition with each other,

FIG. 3a-3d are different views and detail views of the fitting in an open position, and

FIG. 4a-4d are different views and detail views of the fitting in a closed position.

### DETAILED DESCRIPTION OF THE INVENTION

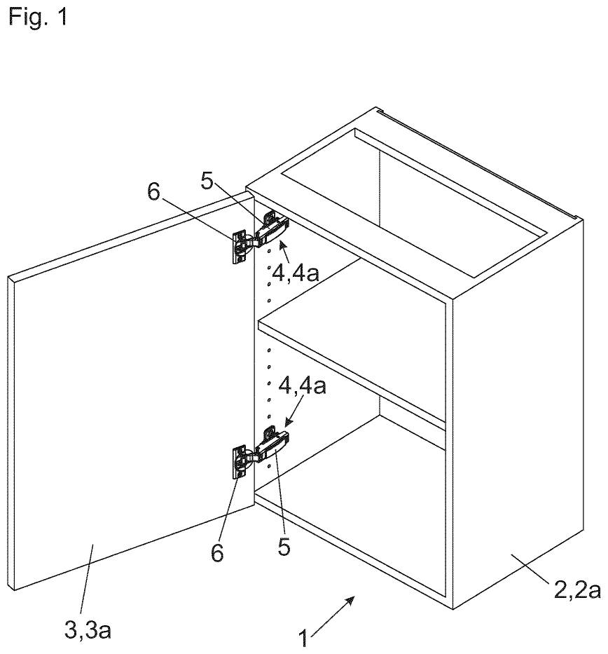

FIG. 1 shows a perspective view of an item of furniture 1 comprising a stationary carrier 2 (for example in the form of a furniture carcass 2a), a movable pivoting element 3 (for example in the form of a movable furniture part 3a), and at least one fitting 4 (for example in the form of hinges 4a) for movably supporting the pivoting element 3 relative to the stationary carrier 2.

The fittings 4 include a first fitting portion 5 configured to be fixed to the stationary carrier 2, and a second fitting portion 6 configured to be fixed to the pivoting element 3. The first fitting portion 5 and the second fitting portion 6 are hingedly connected to each other.

The fitting 4 can include at least one damper 9 (not shown here), the damper 9 being configured to dampen a relative movement of the two fitting portions 5, 6 to each other. By the damper 9, a closing movement and/or an opening movement of the pivoting element 3 until reaching the fully closed end position and/or the fully open position relative to the stationary carrier 2 can be dampened.

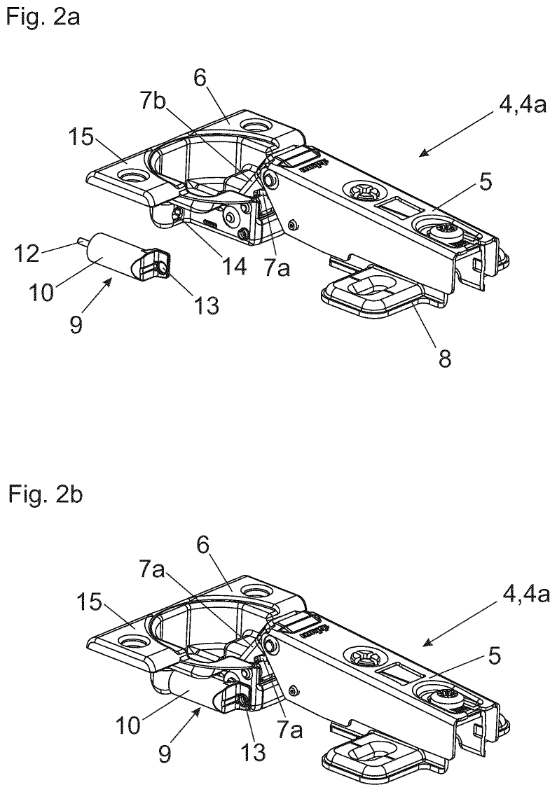

FIG. 2a shows the fitting 4 in the form of the hinge 4a for movably supporting the pivoting element 3 relative to the stationary carrier 2. The fitting 4 includes a first fitting portion 5 configured to be fixed to the stationary carrier 2, and a second fitting portion 6 configured to be fixed to the pivoting element 3. The two fitting portions 5, 6 are pivotally connected to each other via at least one hinge lever 7a, preferably via at least two hinge levers 7a, 7b.

According to an embodiment, the first fitting portion 5 includes a hinge arm and/or the second fitting portion 6 includes a hinge cup.

The fitting 4 can include at least one damper 9 configured to dampen a relative movement of the two fitting portions 5, 6 to each other. For example, the at least one damper 9 can include at least one piston-cylinder-unit having a, preferably cylindrical, damper housing 10, and a piston rod 12 of the damper 9 is displaceably supported relative to the damper housing 10.

The second fitting portion 6 includes a hole 14, and the piston rod 12 of the damper 9 is guided through the hole 14 in a mounted condition.

In the shown embodiment, the damper 9 is configured to be arranged on an outer side of the second fitting portion 6 via at least one fastening location 13. In a mounted condition, the damper 9 is arranged underneath a fastening flange 15 of the second fitting portion 6. The second fitting portion 6, collectively with the damper 9, can be partially arranged within a single cylindrical bore of the pivoting element 3.

FIG. 2b shows the fitting 4 in the form of the hinge 4a according to FIG. 2a with the damper 9 in a mounted condition.

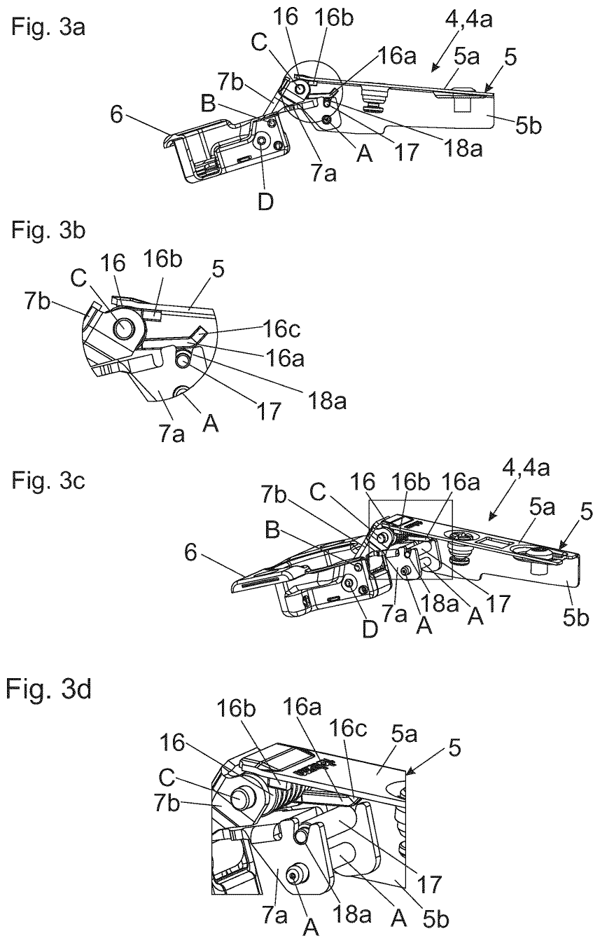

FIG. 3a shows the fitting 4 in the form of the hinge 4a in an open position. The first fitting portion 5 and the second fitting portion 6 are pivotally connected to each other via at least one hinge lever 7a. The at least one hinge lever 7a is pivotally connected to the first fitting portion 5 via at least one hinge axis A, and is pivotally connected to the second fitting portion 6 via at least one hinge axis B.

In the shown embodiment, the first fitting portion 5 and the second fitting portion 6 are pivotally connected to each other via at least two hinge levers 7a, 7b. The second (outer) hinge lever 7b is pivotally connected to the first fitting portion 5 via at least one hinge axis C, and is pivotally connected to the second fitting portion 6 via at least one hinge axis D.

The hinge 4a can be configured as a four-pivot-point hinge, in which the two hinge levers 7a, 7b are pivotally connected to the first fitting portion 5 via two hinge axes A, C, and are pivotally connected to the second fitting portion 6 via two further hinge axes B, D.

The first fitting portion 5 can include a U-shaped portion having a base limb 5a and two transverse limbs 5b projecting from the base limb 5a. In FIGS. 3a-3d, only one transverse limb 5b of the first fitting portion 5 is shown for the sake of improved overview.

By a spring device 16, the two fitting portions 5, 6 are movable relative to each other into a, preferably fully, closed position and/or into a, preferably fully, open position. A first portion 16a, preferably an end portion, of the spring device 16 is supportable on a rotationally mounted support element 17.

In the shown embodiment, the support element 17 is rotationally mounted on the at least one (inner) hinge lever 7a. Due to the co-operation of the portion 16a of the spring device 16 with the rotationally mounted support element 17, a rolling friction is present between these components. As a result, the frictional resistance, the required forces for moving the fitting 4, and the wear can be reduced.

According to preferred embodiments, the at least one support element 17
is arranged adjacent to the hinge axis A of the at least one hinge lever 7a, and/or
is at least partially, preferably substantially entirely, received within the first fitting portion 5, and/or
is configured as a, preferably cylindrical, pin, and/or
has a longitudinal direction extending substantially parallel and/or spaced apart from the hinge axis A of the at least one hinge lever 7a, and/or
has a maximum diameter, and at least one end, preferably two ends, of the support element 17 for supporting, preferably on the at least one hinge lever 7a, has or have a smaller diameter relative to the maximum diameter (see FIG. 3d).

The spring device 16 includes a further portion 16b, preferably an end portion, which can be supported on the base limb 5a of the first fitting portion 5. According to an embodiment, the further portion 16b of the spring device 16 can also be supported on a rotationally mounted support element 17.

The at least one hinge lever 7a can include at least one recess 18a, for example a notch, for rotationally supporting the at least one support element 17.

FIG. 3b shows the encircled region of FIG. 3a in an enlarged view.

According to preferred embodiments, the at least one spring device 16
includes a further portion 16b, preferably a further end portion, supported on the first fitting portion 5, and/or
is supported on a hinge axis C of the fitting 4, and/or
is configured as a helical spring, preferably as a torsion spring, and/or
includes a spring wire having a cross-section deviating from a circular form, preferably having a square or a rectangular cross-section, and/or
includes a spring wire which bears, preferably directly, against the at least one support element 17, and/or
includes at least one bent end portion 16c, and/or
includes a coiling body with two portions 16a, 16b projecting from the coiling body, preferably the portions 16a, 16b of the spring device 16 projecting from the coiling body to a different extent.

Instead of a helical spring, a leaf spring, for example made of a spring steel strip, can also be provided.

In order to further improve the frictional conditions, the at least one support element 17 and/or the portion 16a of the spring device 16 which is configured to bear against the support element 17 is or are at least partially coated with a lubricant, preferably oil or grease.

As an alternative or in addition, for improving the frictional conditions, the at least one support element 17 and/or the portion 16a of the spring device 16 which is configured to bear against the support element 17 can include at least partially a coating, preferably made of plastic.

For example, the coating can be in the form of a gliding body configured to be attached to at least one portion 16a, 16b of the spring device 16. The gliding body can include at least one reservoir for a lubricant. Moreover, the coating can have an outer contour deviating from a cylindrical shape. In this way, a larger contact surface for bearing against the support element 17 can be made available.

FIG. 3c shows the fitting 4 in the form of the hinge 4a in a perspective view, in which the second transverse limb 5b of the at least partially U-shaped first fitting portion 5 is not depicted.

FIG. 3d shows the framed region of FIG. 3c in an enlarged view. The inner hinge lever 7a includes two recesses 18a for pivotally supporting the support element 17. The two recesses 18a are spaced apart from each other in a direction extending in a longitudinal direction of the support element 17.

In the shown embodiment, the support element 17 is a cylindrical pin. At least one end, preferably both ends, of the pin has or have a diameter which is smaller than a maximum diameter of the pin. In this way, the support element 17 can be easily supported on the hinge lever 7a, without the usage of additional components.

According to possible embodiments, the at least one hinge lever 7a
includes at least one recess 18a, preferably at least two recesses 18a, for supporting the at least one support element 17, and/or
is configured at least partially U-shaped in a cross-section, and/or
is configured at least partially curved, and/or
is pivotally supported about a first hinge axis A on the first fitting portion 5, and is pivotally supported about a second hinge axis B on the second fitting portion 6.

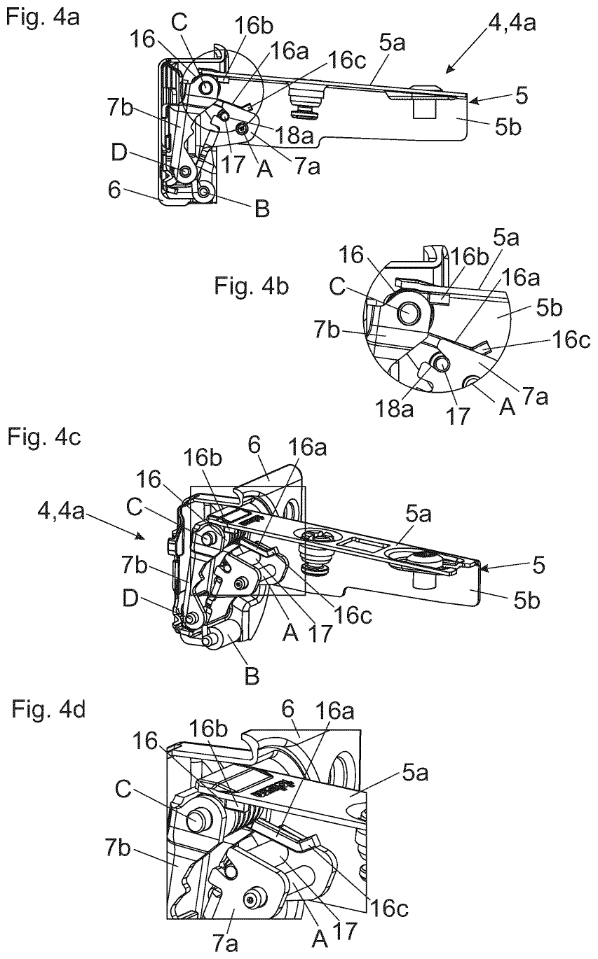

FIG. 4a shows the fitting 4 in the form of the hinge 4a located in a closed position.

FIG. 4b shows the encircled region of FIG. 4a in an enlarged view. A first portion 16a of the spring device 16 is supported on the rotationally mounted support element 17, and a second portion 16b of the spring device 16 is supported on the first fitting portion 5, preferably on an underside of the base limb 5a of the first fitting portion 5.

FIG. 4c shows a perspective view of the fitting 4 located in a closed position.

FIG. 4d shows the framed region of FIG. 4c in an enlarged view.

1. A fitting for movably supporting a pivoting element, the fitting comprising:
a first fitting portion to be fixed to a carrier,
a second fitting portion to be fixed to the pivoting element,
at least one hinge lever pivotally supported about at least one hinge axis, the at least one hinge lever hingedly connecting the first fitting portion and the second fitting portion to each other,
at least one spring device for moving the two fitting portions into a, preferably fully, closed position and/or into a, preferably fully, open position relative to each other, and
at least one support element on which a portion, preferably an end portion, of the spring device is supported,
wherein the at least one support element for supporting the spring device is rotationally mounted, preferably on the at least one hinge lever.

2. The fitting according to claim 1, wherein the fitting includes an inner hinge lever and an outer hinge lever, wherein the at least one support element is rotationally mounted on the inner hinge lever.

3. The fitting according to claim 1, wherein the at least one support element:
is arranged adjacent to the hinge axis of the at least one hinge lever, and/or
is at least partially, preferably substantially entirely, received within the first fitting portion, and/or
is configured as a, preferably cylindrical, pin, and/or
has a longitudinal direction extending substantially parallel and/or spaced apart from the hinge axis of the at least one hinge lever, and/or
has a maximum diameter, wherein at least one end, preferably two ends, of the support element for supporting, preferably on the at least one hinge lever, has or have a smaller diameter relative to the maximum diameter.

4. The fitting according to claim 1, wherein the at least one spring device:
includes a further portion, preferably a further end portion, supported on the first fitting portion, and/or
is supported on a hinge axis of the fitting, and/or
is configured as a helical spring, preferably as a torsion spring, and/or
includes a spring wire having a cross-section deviating from a circular form, preferably having a square or a rectangular cross-section, and/or
includes a spring wire which bears, preferably directly, against the at least one support element, and/or
includes at least one bent end portion, and/or
includes a coiling body with two portions projecting from the coiling body, preferably wherein the portions of the spring device project from the coiling body to a different extent.

5. The fitting according to claim 4, wherein the first fitting portion includes a U-shaped portion having a base limb and two transverse limbs projecting from the base limb, wherein the further portion of the spring device is supported on the base limb of the first fitting portion.

6. The fitting according to claim 1, wherein the fitting is configured as a four-pivot-point hinge, wherein two hinge levers are pivotally connected to the first fitting portion via two hinge axes, and are pivotally connected to the second fitting portion via two further hinge axes.

7. The fitting according to claim 1, wherein the at least one hinge axis of the hinge lever is arranged on the first fitting portion.

8. The fitting according to claim 1, wherein the first fitting portion includes a hinge arm and/or the second fitting portion includes a hinge cup.

9. The fitting according to claim 1, wherein the at least one support element and/or the portion of the spring device which is configured to bear against the support element is or are at least partially coated with a lubricant, preferably an oil or a grease.

10. The fitting according to claim 1, wherein the at least one support element and/or the portion of the spring device which is configured to bear against the support element includes or include at least partially a coating, preferably made of plastic.

11. The fitting according to claim 1, wherein the at least one hinge lever:
includes at least one recess, preferably at least two recesses, for supporting the at least one support element, and/or
is configured at least partially U-shaped in a cross-section, and/or
is configured at least partially curved, and/or
is pivotally supported about a first hinge axis on the first fitting portion, and is pivotally supported about a second hinge axis on the second fitting portion.

12. The fitting according to claim 1, wherein the fitting includes at least one damper, preferably a piston-cylinder-unit, configured to dampen a relative movement of the two fitting portions to each other.

13. The fitting according to claim 12, wherein the at least one damper is arranged on or within of one of the two fitting portions.

14. The fitting according to claim 1, wherein the fitting is configured as a hinge for moving a movably-supported furniture part.

15. An item of furniture comprising a stationary carrier, in particular a furniture carcass, a pivoting element, in particular a movable furniture part, movable relative to the stationary carrier, and at least one fitting according to claim 1 for moving the movable pivoting element, wherein the first fitting portion of the fitting is fixed to the stationary carrier, and the second fitting portion of the fitting is fixed to the pivoting element.

16. The fitting according to claim 1, wherein the fitting is a hinge for movably supporting a furniture part, a window, or a door relative to a stationary carrier.
